(19) United States
(12) Patent Application Publication
(10) Pub. No.: US 2005/0007778 A1
(43) Pub. Date: Jan. 13, 2005

(54) Lamp structure for an electrical device

(76) Inventor: Jack Lin, Taoyuan Hsien (TW)

Correspondence Address: Yi-Wen Tseng, 509 ROOSEVELT BLVD. #D306, FALL CHURCH, VA, 22044, US

(21) Appl. No.: 10/614,103

(22) Filed: Jul. 8, 2003

(51) Int. Cl. F21L 4/04; F21V 21/14

(52) U.S. Cl. 362/250; 362/198; 362/191

(57) ABSTRACT

A lamp structure for an electrical device including a support portion and a socket portion is disclosed. The support portion includes at least one clamp element, and a flexible tube with an adapter mounted at the top end thereof. The socket portion pivotally connected to the adapter on one end thereof includes two separated conductors with a plurality of light elements located thereon, each light element having two pin legs electrically connected to the conductors, respectively. Each conductor includes a folded and elastic holding part on one side thereof, and a plurality of plugholes formed above the holding part so that two pin legs of each light element are passed through the plughole to be held by two holding parts, respectively.

### BACKGROUND OF THE INVENTION

The present invention relates generally to a lamp structure for an electrical device and, more particularly, to a lamp structure for use in a portable electrical device such as a laptop computer to provide sufficient illumination.

In the progress of the technology, it is well know a portable electrical device such as a laptop computer to facilitate the life of the human beings. The portable electrical device is convenient due to its portability for use anytime and anywhere. However, in practical, there is the problem to use the portable electrical device in the dark or in poor-light environment; therefore, there is a conventional lamp device for providing extra illumination.

FIG. 1 is a perspective view of a conventional lamp structure for use in the laptop computer (not shown). It can provide the extra illumination for a user to operate the laptop computer.

The conventional lamp device 10 includes a base 101 with a clamp element 102 on one side for grasping on the LCD of the laptop computer. A bellows tube 103 is mounted on the base 101, which is flexible to be adjusted so that a bulb 105 mounted in a socket 104 can provides the laptop computer an appropriate illumination.

However, the conventional lamp device 10 is mounted on one edge of the LCD, and the bulb 105 provides only an element light; therefore, the illumination may be insufficient.

Therefore, there exist inconvenience and drawbacks for practically application of the above conventional lamp structure. There is thus a substantial need to provide an improved lamp structure that resolves the above drawbacks and can be used more conveniently and practically.

### BRIEF SUMMARY OF THE INVENTION

The present invention provides a lamp structure for an electrical device having a plurality of aligned lighting elements to provide sufficient illumination for the electrical device such as a laptop computer so that it is convenient for the user to operate the laptop computer in dark or poor-light environment.

Another object of the present invention is to provide a lamp device with different power supplying sources to be selected by the user so as to obtain the facilitation of use.

In order to achieve the above-mentioned objects, a lamp structure provided by the present invention includes a support portion and a socket portion. The support portion includes at least one clamp element, and a flexible tube with an adapter mounted at the top end thereof. The socket portion pivotally connected to the adapter on one end thereof includes two separated conductors with a plurality of light elements located thereon, each light element having two pin legs electrically connected to the conductors, respectively. Each conductor includes a folded and elastic holding part on one side thereof, and a plurality of plugholes formed above the holding part so that two pin legs of each light element are passed through the plugholes to be held by two holding parts, respectively.

Furthermore, a lamp structure provided by the present invention includes two wires connected to the respective conductors extending through the flexible tube. The support portion further includes a base for containing batteries coupled with the wires to supply power. Besides, a connector such as a USB connector or a plug is formed at the ends of the wires; therefore, the power is supplied by connecting the connector to the laptop computer or pluging the connector to a power socket.

Therefore, the present invention installs a light emitting diode and a switch on a push handle of a car cigarette lighter, such that when the lighter is conducted, the user or driver can easily observe the conducting status by the light generated by the light emitting diode.

### BRIEF DESCRIPTION OF THE DRAWINGS

These, as well as other features of the present invention, will become more apparent upon reference to the drawings wherein:

FIG. 1 shows a perspective view of a conventional lamp device;

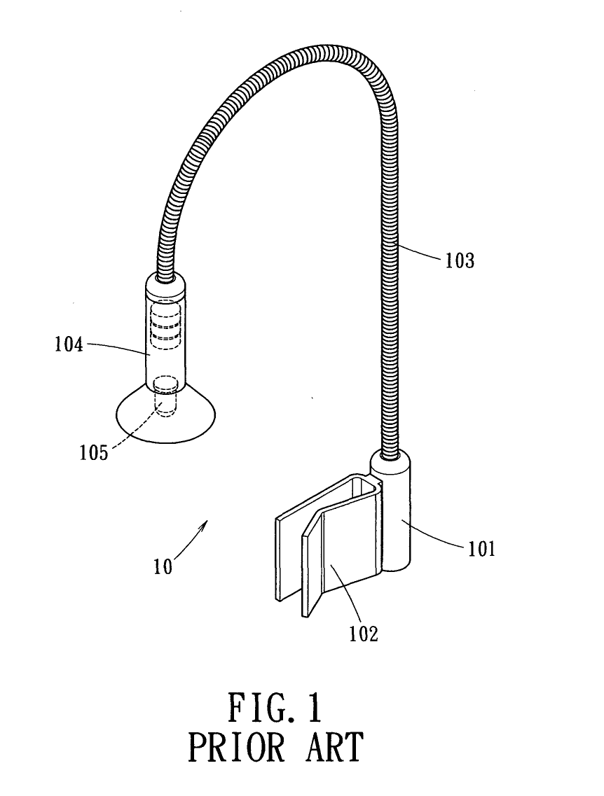

FIG. 2 shows an exploded view of a lamp structure according to the present invention;

FIG. 3 shows an exploded view of a socking potion of the lamp structure;

FIG. 4 shows a front-end view of the socket portion according to the present invention;

FIG. 5 shows the assembly of the socket portion according to the present invention;

FIG. 6 shows the assembly of the lamp structure according to a preferred embodiment of the present invention;

FIG. 7 shows an application of the lamp structure for a laptop computer;

FIG. 8 shows a lamp structure according to another preferred embodiment of the present invention; and

FIG. 9 shows a lamp structure according to still another preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

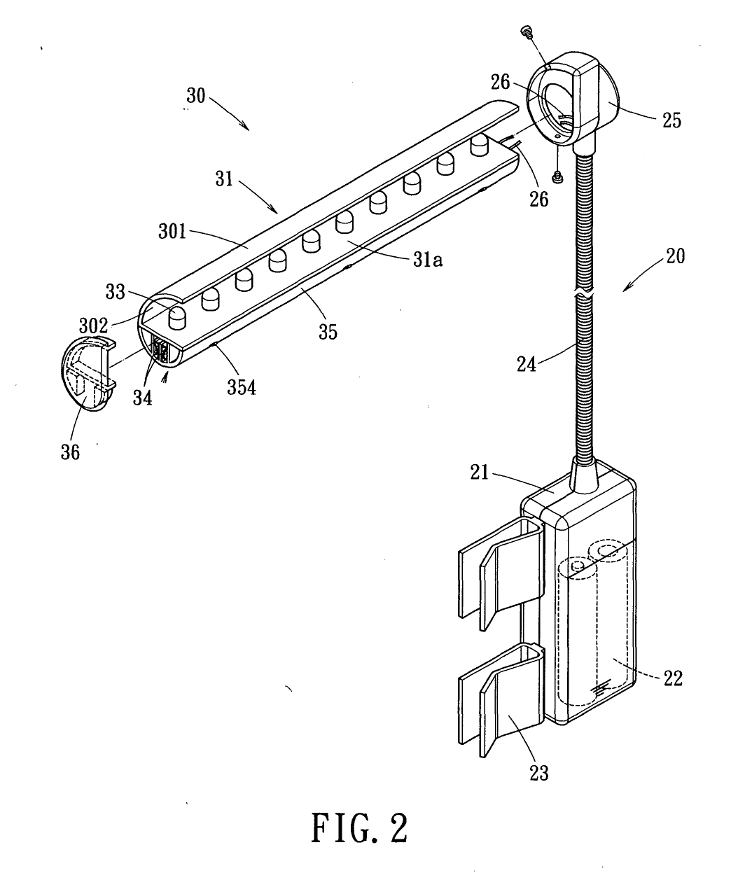

Referring to FIG. 2, a lamp structure for an electrical device such as a laptop computer to provide sufficient illumination according to the present invention includes a support portion 20 and a socket portion 30.

The support portion 20 includes a base 21 for containing batteries 22. There is at least one clamp element 23 formed on one side of the outer surface of the base 21. In this preferred embodiment, there are two clamp elements 23 for grasping on the LCD of the laptop computer.

The support portion 20 further includes a flexible tube 24 such as a bellows tube mounted on the base 21 at one end. An adapter 25 is mounted on the other end of the flexible tube 24 for pivotally connecting the socket portion 30. Therefore, the wires 26 can be extended from the socket portion 30 to pass through inside the flexible tube 24 to be coupled with the batteries 22.

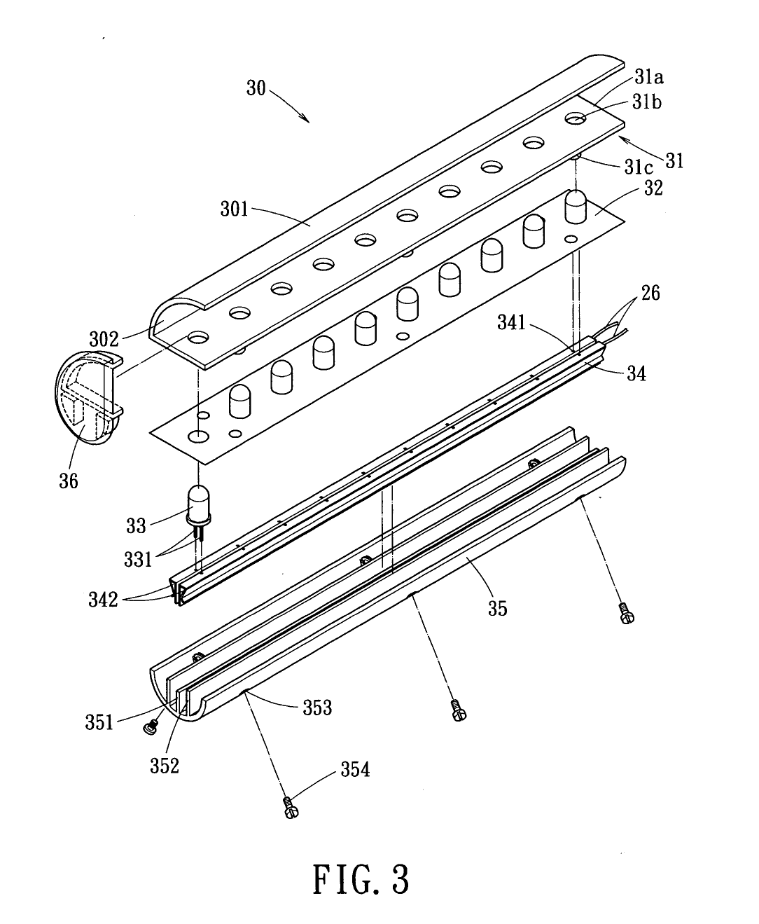

Referring to FIGS. 3 to 5, the socket portion 30 includes a strip light cover 31, a fixing plate 32, a plurality light elements 33, two separate conductors 34 and a semi-cylinder seat 35.

The strip light cover 31 includes a bottom plate 31a connected with an arc-shaped light mask 301 to be formed above the bottom plate 31a. The inner surface 302 of the light mask 301 facing the bottom plate 31a is a reflective surface for reflecting the incident light.

There are a plurality aligned holes 31b formed on the bottom plate 31a, and a plurality of screw posts 31c with bevel thread inside formed on the bottom surface of the bottom plate 31a. Each light element 33 furnished on the fixing plate 32 is penetrated through a corresponding hole 31b of the bottom plate 31a to locate inside the cover 31. The fixing plate 32 is made of an insulated material like plastic and is located between the cover 31 and the seat 35 for safety consideration.

The light elements 33 are bright light emitting diodes (LEDs) required lower supply to save the power. Two positive and negative electrode pin legs 331 of the light element 33 are coupled to two plugholes 341 of the conductor 34, respectively.

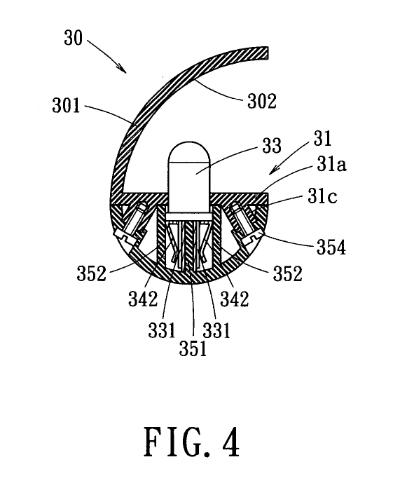

One end of each conductor 34 is connected with the wires 26 to be as the positive or negative electrode. Two symmetrically folded and elastic holding parts 342 are formed on the conductors 34. The plurality pairs of plugholes 341 are formed above the holding parts 342 to have each pair of pin legs 331 passing through the corresponding pair of plugholes 341 to be held in the holding parts, as shown in FIG. 4. Therefore, the pin legs 331 of light elements 33 are stably contacted with the conductors 34, and the light elements 33 are firmly mounted on the conductors 34.

The seat 35 with an arc shape includes an insulating plate 351 in the middle to separate two conductors 34 located in the seat 35, and two block plates 352 formed on either sides of the insulating plate 351, respectively. Each holding part 342 of the conductors 34 is fixed between the corresponding block plate 352 and the insulating plate 351.

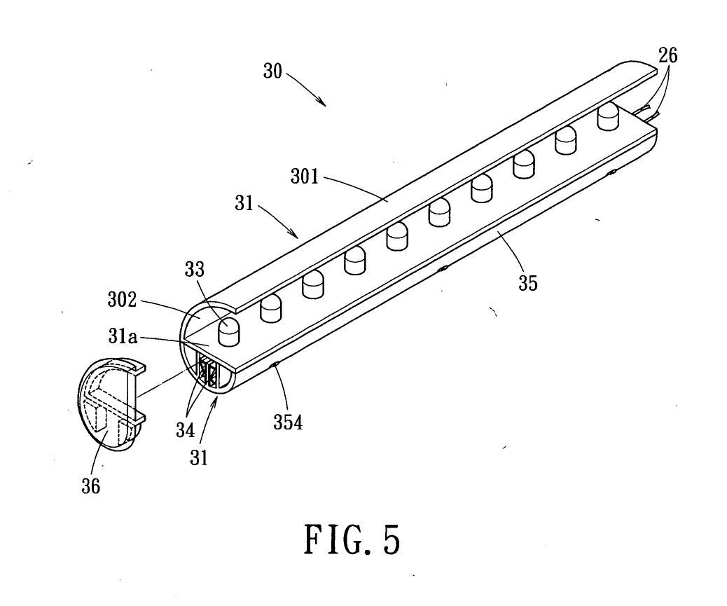

There are a plurality of screw holes with respect to the screw posts 31c formed on the seat 35 for a plurality of bolts to combine the strip light cover 31 and the semi-cylinder seat 35. Furthermore, a cap 36 is used to cover on the other end of the socket portion 30, as shown in FIG. 5.

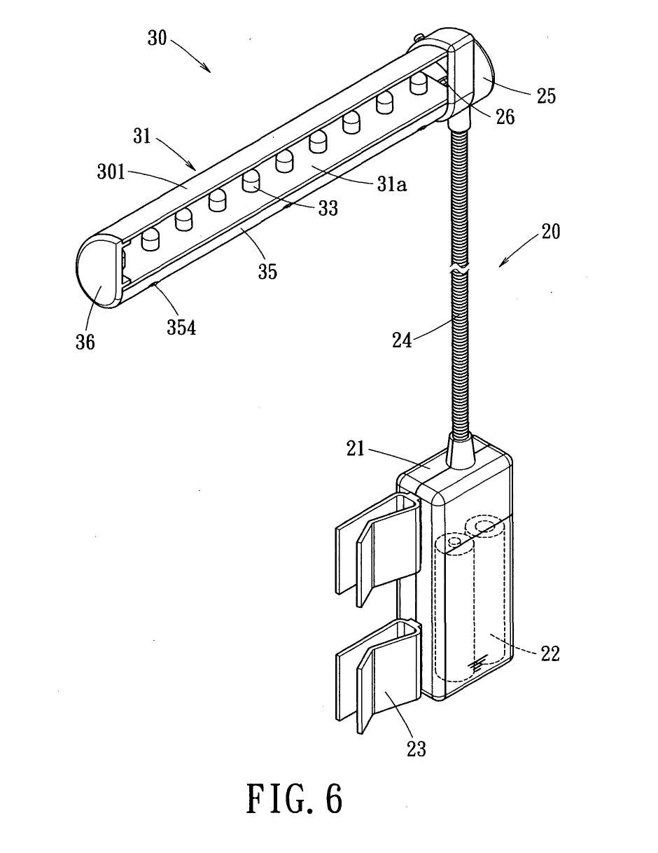

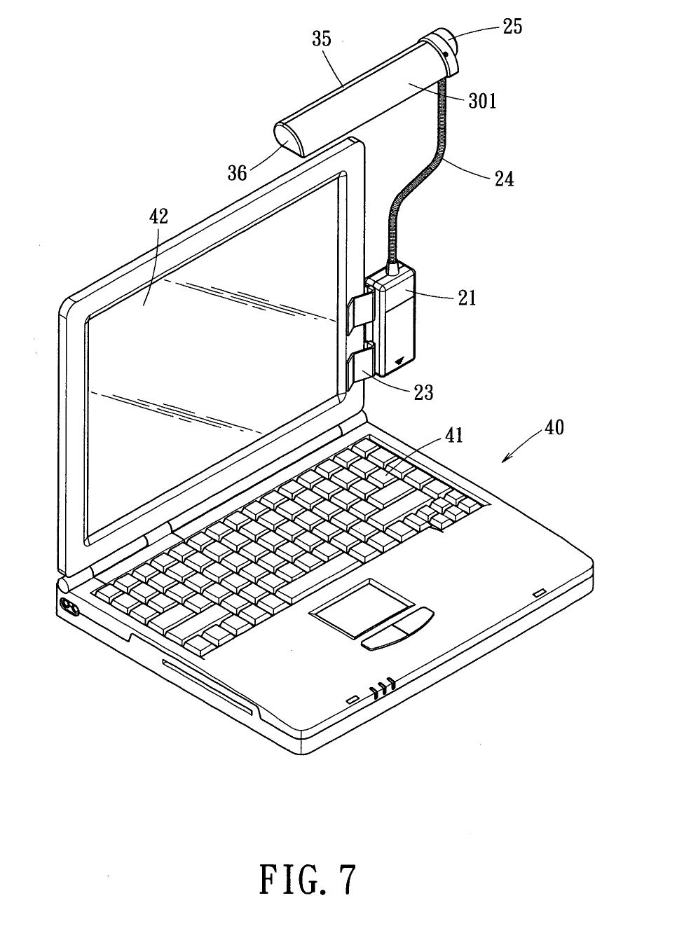

Please refer to FIGS. 6 and 7. The lamp device according to the prevent invention is held on an edge of the LCD 42 of a laptop computer 40 by the clamping elements 23. The aligned light elements 33 in the socket potion 30 provide sufficient illumination to the keyboard 41 and the LCD 42 so as to facilitate the user's operation of the laptop computer 40 in the dark or in poor-light environment.

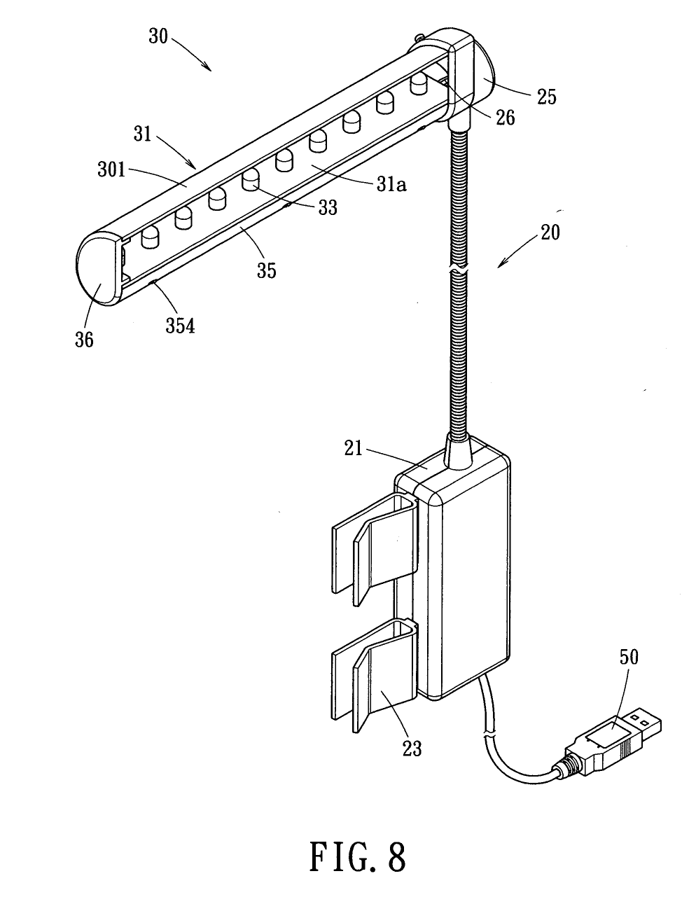

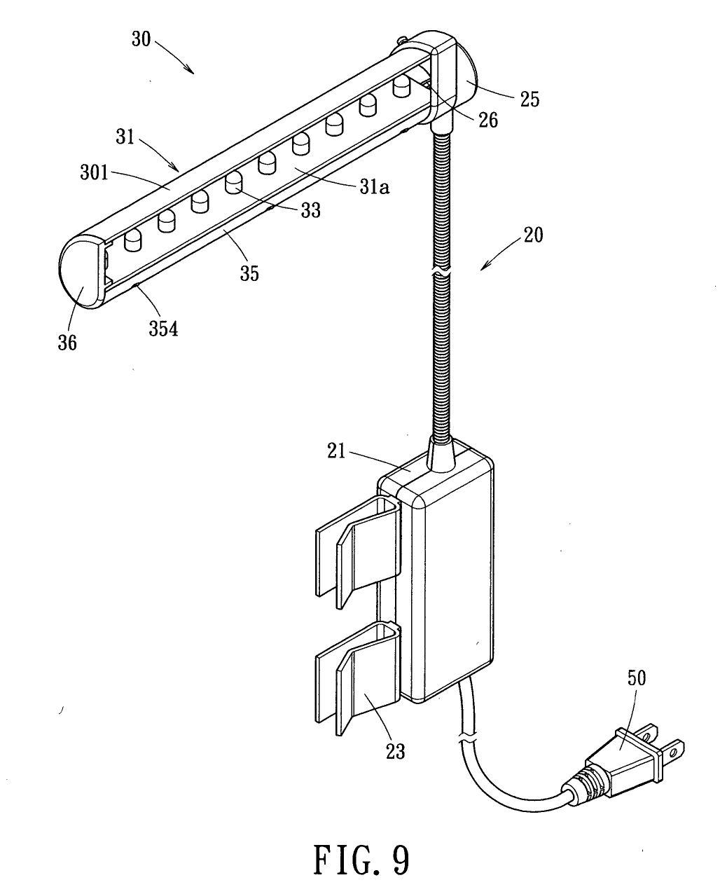

Referring to FIGS. 8 and 9, another preferred embodiments of the lamp structure according to the present invention are illustrated. A connector 50 is further extended from the base 21 of the support portion 20 to obtain the outsourcing power supply. In FIG. 8, the connector 50 is a USB connector for connecting to a USB port of the laptop computer. In FIG. 9, the connector 50 is a plug for connecting to a power socket.

According to the lamp structure of the present invention, it provides at least the advantages as follows.

1. Two conductors 34 are used to associate lots of light elements in the socket portion 30; therefore, the sufficiently bright illumination can be obtained.

2. There provide different power supplying sources of the batteries 22, and the USB or plug connector 50 to be selected by the user so as to provide the facilitation of use.

3. The pair of pin legs 331 of each light element 33 are held by the holding parts 342; therefore, the assembly of the light elements 33 and the conductors are simple and delicate to reduce the cost.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A lamp structure for an electrical device, comprising:
a support portion including at least one clamp element, and a flexible tube with an adapter mounted at the top end thereof; and
a socket portion pivotally connected to the adapter, including two separated conductors with a plurality of light elements located thereon, each light element having two pin legs electrically connected to the conductors, respectively.

2. The lamp structure of claim 1, wherein the support portion further includes a base for containing at least on battery, and two wires coupled between the conductors and the battery.

3. The lamp structure of claim 2, wherein the clamp element is mounted on one side of the base.

4. The lamp structure of claim 1, wherein the flexible tube is a bellows tube.

5. The lamp structure of claim 1, wherein the socket portion includes a strip light cover having a plurality of screw posts with bevel thread inside formed on the bottom surface thereof, and a semi-cylinder seat with a plurality of screw holes with respect to the screw posts so as to combine the cover and the seat by a plurality of bolts.

6. The lamp structure of claim 5, wherein the cover includes a bottom plate connected with an arc-shaped light mask to be formed thereabove, and the light mask facing the bottom plate is a reflective surface.

7. The lamp structure of claim 5, wherein the socket portion further includes an insulated plate with the light elements mounted between the cover and the seat.

8. The lamp structure of claim 5, wherein the socket portion further includes a cap covering on one end thereof, the other end of the socket portion is connected to the adapter.

9. The lamp structure of claim 5, wherein the seat includes an insulating plate to separate the two conductors.

10. The lamp structure of claim 9, wherein the seat further includes two block plates formed on either sides of the insulating plate, respectively, each conductor is fixed between a corresponding block plate and the insulating plate.

11. The lamp structure of claim 1, wherein the socket portion includes two wires connected to the conductors, respectively, and extended through the flexible tube to form a connector on the ends thereof.

12. The lamp structure of claim 1, wherein the connector is a universal serial bus (USB) connector or a plug.

13. The lamp structure of claim 1, wherein each conductor includes a folded and elastic holding part on one side thereof, and a plurality of plugholes formed above the holding part so that two pin legs of each light element are passed through the plughole to be held by two holding parts, respectively.

14. The lamp structure of claim 1, wherein the light elements are light emitting diodes (LEDs).
